(19) United States
(12) Patent Application Publication
(10) Pub. No.: US 2007/0292586 A1
(43) Pub. Date: Dec. 20, 2007

(54) Method for Producing Dishes Served in Sauce

(76) Inventor: Bertrand Arbogast, La Wantzenau (FR)

Correspondence Address: OLIFF & BERRIDGE, PLC, P.O. BOX 320850, ALEXANDRIA, VA, 22320-4850, US

(21) Appl. No.: 10/591,526

(22) PCT Filed: Feb. 28, 2005
(86) PCT No.: PCT/FR05/00472

§ 371 Date: Jun. 13, 2007

(30) Foreign Application Priority Data
Mar. 1, 2004 (FR) 0402095

(51) Int. Cl. B65B 55/14; A23L 1/39; A23L 1/48; A23L 3/10; A23L 3/18; B65B 55/18; B65B 25/00; B65B 55/02; B65B 55/04; B65B 55/12

(52) U.S. Cl. 426/589

(57) ABSTRACT

A method for producing dishes served in sauce containing food products such as vegetables, fruits, dairy products and meets, whereby preserving them for several months without adding preservatives and/or coloring agents and without sterilization. This method consists of: proceeding with cooking in a pot, fresh ingredients mixed with seasoning products such as salt, pepper, spices, hot peppers, and with animal and/or vegetable fat for a duration of 20 minutes up to 6 hours at a minimum temperature of 80° C.; hot packaging the thereby obtained sauce in a clean container at a temperature above 80° C., the packages being closed immediately after filling; and rapidly cooling said packages filled with sauce, for a duration less than 2 hours depending on the volume of the latter, at a temperature less than 10° C.

The present invention relates to a method for producing dishes served in sauce containing food products such as vegetables, fruits, meat, dairy products, etc., whereby preserving them for several months without any sterilization or pasteurization, or any addition of additives of the preservative and/or coloring agent type.

Present regulations establish a difference between sterilized products which may benefit from long preservation, which may be stored for months or even years without any alteration, and fresh or pasteurized products which the consumer should generally keep in a cooled place, and which should basically be consumed relatively rapidly.

Of course, the problem related with long preservation lies in preserving over time the various ingredients involved in elaborating the finished product. In particular, when these foodstuffs are meats or vegetables such as those used in making sauce, it is matter of avoiding any bacteriological problem for an authorized consumption period of at least several months.

To guarantee destruction of micro-organisms in a foodstuff, so as to avoid transmission of pathogenic germs and development of alterations in the actual product, the product may undergo a treatment of the sterilization type on the one hand, and receive chemical additives on the other hand. The purpose of the latter is first to prevent development of said micro-organisms or of their spores, in order to retain innocuousness of the product. Second, certain additives may also be used with the purpose of retaining the visual aspect of the product, so that, even if it is still consumable, the latter has not radically changed in aspect (for example in color), between the instant of its purchase and the instant of its consumption.

This is why in most cases, the products for example of the sauce type, the limiting consumption date of which is set several months after their being introduced on the market, comprise both additives belonging to the category of preservatives and additives which in reality are coloring agents. This is particularly true for tomato-based sauces, the visual aspect of which the consumer pays attention to, which should remain in a red spectrum, otherwise the consumer may have doubts on the quality of the purchased foodstuff.

All these long preservation products moreover undergo a treatment, generally based on heat, in order to destroy bacteria therein, and more generally all the micro-organisms capable of generating pathologies. In most cases, the heat treatment used is sterilization which is carried out at a higher temperature than pasteurization, after making and packaging the sauces. Upon sterilization, the products are heated according to a time/temperature curve which varies according to the products.

The problem is that sterilization has a direct effect on the taste of the product. Furthermore, this effect is not trivial, as for example the taste of a sauce is significantly altered by the dual action of the additives which were introduced therein and by the intensity of the sterilization process which it has undergone. Pasteurization also causes a change in taste.

Of course this drawback does not affect fresh products, for which on the other hand the processes in effect as regards hygiene and food, impose limiting shelf lives very close to their date of introduction on the market, in order to avoid any harmful development of micro-organisms. These fresh products, often including additional components aimed at preventing development of these micro-organisms, bacteria, etc., have not however undergone a treatment of the sterilization type for destroying the latter, the proliferation of which may from then on occur fairly rapidly.

In other words, the presently available alternative on the market consists in products which may be consumed for long periods, for which the taste and flavor have been substantially altered by sterilization, and in products described as fresh, for which the gustatory properties are conversely better preserved but which cannot be kept for more than a few weeks, in spite of the possible use of packaging under vacuum or under a modified atmosphere, and of the frequent use of additives and preservatives.

The present invention suggests changing this established fact. The manufacturing method which is the object thereof, indeed leads to a surprising and totally unexpected result, insofar that sauces resulting there from, although having not undergone any sterilization or pasteurization after being packaged, and in the absence of additives or preservatives, were able to be kept for several months without losing their gustatory properties while retaining their innocuousness for the consumer since their stability was established.

Stated otherwise, the sauces made according to the method of the invention retain a remarkable flavor, in this case the one they have at the end of cooking the fresh foodstuffs which compose them and even after a long period, this flavor is again found as it was. Many tests were carried out, which agree perfectly and which show that there is no bacteriological problem, not even a minor one, during a limiting shelf life of a least 3 months, insofar that the product was stored in a cool place. In reality, these tests even show that the product remains stable for more than 3 months.

To obtain this result, the method is characterized in that it consists of:
proceeding with cooking in a pot of fresh ingredients mixed with seasoning products such as salt, pepper, spices, hot peppers and with animal and/or vegetable fat for a duration of 20 minutes up to 6 hours at a minimum temperature of 80° C.;
hot packaging the sauce in a clean container at a temperature of about 80° C., the packages being closed immediately after filling, and
rapidly cooling said packages filled with sauce, for a period less than 2 hours depending on the volume of the latter, at a temperature less than 10° C.

By observing the succession and the contents of these steps, it is possible to retain a very fresh taste, very true to the original taste, even after several months of storage of the sauce, and this in spite of the absence of any preservative or high temperature treatment of the finished product.

The products made by means of the method of the invention have been regularly tested, and it was noticed that after 2 months, 3 months, or even 6 months, the results were always the same, without any gustatory or bacteriological deterioration.

After packaging into sealed cans, rapid cooling is carried out in an enclosure brought to a temperature between 0° C. and −25° C.

One of the consequences of this cooling is notably causing a certain vacuum inside the can. This at least partial vacuum which neither changes the flavor properties or the taste of the product, plays a role in better preservation of the sauces in their package; Indeed, it is hardly favorable to the development of at least a certain number of micro-organisms likely to thrive in said sauces.

The cooling period as mentioned, depends on the volume of the package. More specifically, according to the invention, the goal is to reach a core temperature of less than 6° C. within the shortest time possible.

Preferably, in order to obtain the effect specific to the invention, the cooking temperature in the pot should be between 95° C. and 105° C. in the core.

It should be noted that because of the designation “fresh product”, storage of the product in a cooled atmosphere is recommended to the consumer by an indication on the package. This being the case, different tests of stability were carried out on sauces made with the method of the invention, and which were not stored in a cool place. These tests, which are notably based on measuring the pH of the sauce, show that for certain sauces, the condition of storage in a cooled place is not determining. Surprisingly the product remains stable over a period of several months, which involves the unexpected effect resulting from the invention.

The sauces which are concerned by the method of the invention are for example tomato-based sauces, used in cooking, notably in Italian cooking, for seasoning pasta. Thus, these may be Bolognese type sauces, etc. It should be noted that the method of the invention is for example applied to sauces for which the basic ingredients were mentioned before, which by no means foresees adding additional ingredients such as alcohol in order to give a particular taste to certain recipes.

Addition of other ingredients from the moment that they do not change the characteristics of the method, is perfectly possible and depends on the imagination of the cook and on the type of taste which is sought after.

1. A method for producing dishes served in sauce containing food products such as vegetables, fruits, dairy products and meets, whereby preserving them for several months without adding preservatives and/or coloring agents and without sterilization, characterized in that it consists of:
proceeding with cooking in a pot, fresh ingredients mixed with seasoning products such as salt, pepper, spices, hot peppers, and with animal and/or vegetable fat for a duration of 20 minutes up to 6 hours at a minimum temperature of 80° C.;
hot packaging the thereby obtained sauce in a clean container at a temperature above 80° C., the packages being closed immediately after filling; and
rapidly cooling said packages filled with sauce, for a duration less than 2 hours depending on the volume of the latter, at a temperature less than 10° C.

2. The method for producing sauces according to claim 1, wherein the rapid cooling is carried out in an enclosure brought to a temperature between 0° C. and −25° C.

3. The method for producing sauces according to claim 1, wherein the cooking temperature in the pot is between 95° C. and 105° C. in the core.

4. The method for producing sauces according to claim 2, wherein the cooking temperature in the pot is between 95° C. and 105° C. in the core.
